(19) United States
(12) Patent Application Publication
(10) Pub. No.: US 2012/0182897 A1
(43) Pub. Date: Jul. 19, 2012

(54) METHOD AND APPARATUS FOR NETWORK ENTRY IN HETEROGENEOUS NETWORK

(75) Inventor: Shuangfeng Han, Suwon-si (KR)

(73) Assignee: SAMSUNG ELECTRONICS CO., LTD., Suwon-si (KR)

(21) Appl. No.: 13/353,186

(22) Filed: Jan. 18, 2012

(30) Foreign Application Priority Data
Jan. 18, 2011 (KR) 10-2011-0004900

(51) Int. Cl. H04W 72/04; H04W 24/00

(52) U.S. Cl. 370/252; 370/329; 370/330

(57) ABSTRACT

An apparatus and a method for manage network entry in a heterogeneous network (HetNet). In the method for network entry of a terminal in a HetNet, a base station access signal for network entry is transmitted to a serving base station. A response message is received from the serving base station. An uplink parameter is controlled based on an indication of the serving base station included in the response message. An access request message is generated and transmitted to the serving base station. A downlink response message including information regarding a selected serving base station is received from the serving base station. An access response message including information for network entry is received from the selected serving base station. A network entry procedure is performed with the selected serving base station.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Jan. 18, 2011 and assigned Serial No. 10-2011-0004900, the entire disclosure of which is hereby incorporated by reference.

### TECHNICAL FIELD OF THE INVENTION

The present disclosure relates to a heterogeneous network (HetNet).

### BACKGROUND OF THE INVENTION

Heterogeneous Network (HetNet) is being studied and will become a kind of a network which will be primarily utilized in the future. The HetNet includes a macro base station and a femto cell.

However, a network entry procedure of a terminal for accessing a macro base station or a femto base station in the HetNet uses a method of trying an access to all accessible base stations, without knowing a base station at which the terminal will show best performance. This network entry procedure is not efficient.

Therefore, a method and an apparatus for overcoming the above-described problem are required.

### SUMMARY OF THE INVENTION

To address the above-discussed deficiencies of the prior art, it is a primary aspect of the present disclosure is to address at least the above-mentioned problems and/or disadvantages and to provide at least the advantages described below. Accordingly, an aspect of the present disclosure is to provide a method and an apparatus for network entry in a HetNet.

In accordance with an aspect of the present disclosure, a method for network entry of a terminal in a heterogeneous network (HetNet) is provided. The method includes transmitting a base station access signal for network entry to a serving base station, receiving a response message from the serving base station, controlling an uplink parameter based on an indication of the serving base station included in the response message, generating an access request message and transmitting the same to the serving base station, receiving a downlink response message including information regarding a selected serving base station from the serving base station, receiving an access response message including information for network entry from the selected serving base station, and performing a network entry procedure with the selected serving base station.

In accordance with another aspect of the present disclosure, a method for operating a base station for network entry of a terminal in a heterogeneous network (HetNet) is provided. The method includes: receiving a base station access signal from a terminal, when receiving an uplink parameter regarding the terminal from a different base station, transmitting the uplink parameter to the terminal that generates a response message including an uplink parameter, receiving an access request message from the terminal, determining a selected serving base station that the terminal is to access based on a base station ID included in the access request message, and transmitting information regarding the selected serving base station to the terminal.

In accordance with still another aspect of the present disclosure, a method for operating a base station for network entry of a terminal in a heterogeneous network (HetNet) is provided. The method includes receiving a base station access signal from a terminal, determining whether reception power of the base station access signal is equal to or greater than a threshold, when the reception power of the base station access signal is equal to or greater than the threshold, transmitting an uplink parameter regarding the terminal to a serving base station, when receiving a message including information informing a selected serving base station from the serving base station, transmitting an access response message including information for network entry of the terminal to the terminal, and performing a network entry procedure with the terminal.

In accordance with further another aspect of the present disclosure, an apparatus of a terminal for network entry in a heterogeneous network (HetNet) is provided. The apparatus includes a modem for communicating with a base station, and a controller for transmitting a base station access signal for network entry to a serving base station, receiving a response message from the serving base station, controlling an uplink parameter, generating an access request message, transmitting the same to the serving base station based on indication of the serving base station included in the response message, receiving a downlink response message including information regarding a selected serving base station from the serving base station, receiving an access response message including information for network entry from the selected serving base station, and performing a network entry procedure with the selected serving base station.

In accordance with further yet another aspect of the present disclosure, an apparatus of a base station for network entry of a terminal in a heterogeneous network (HetNet) is provided. The apparatus includes a modem for communicating with the terminal, a backhaul communication unit for communicating with a different base station, and a network entry manager for receiving a base station access signal from the terminal, when receiving an uplink parameter for the terminal from a different base station, transmitting the uplink parameter to the terminal that generates a response message including the uplink parameter, receiving an access request message from the terminal, determining a selected base station which the terminal is to access based on a base station ID included in the access request message, and transmitting information regarding the selected serving base station to the terminal.

In accordance with still further yet another aspect of the present disclosure, an apparatus of a base station for network entry of a terminal in a heterogeneous network (HetNet) is provided. The apparatus includes a modem for communicating with the terminal, a backhaul communication unit for communicating with a different base station, and a network entry manager for receiving a base station access signal from the terminal, determining whether reception power of the base station access signal is equal to or greater than a threshold, when the reception power of the base station access signal is equal to or greater than the threshold, transmitting an uplink parameter for the terminal to a serving base station, when receiving a message including information informing a selected serving base station from the serving base station, transmitting an access response message including information for network entry of the terminal to the terminal, and performing a network entry procedure with the terminal.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a network entry procedure of a terminal according to an exemplary embodiment of the present disclosure;

FIG. 2 illustrates a network entry procedure of a terminal according to an exemplary embodiment of the present disclosure;

FIG. 3 illustrates a network entry procedure of a serving base station for a terminal according to an exemplary embodiment of the present disclosure;

FIG. 4 illustrates a network entry procedure of a selected serving base station for a terminal according to an exemplary embodiment of the present disclosure;

FIG. 5 illustrates a terminal according to an exemplary embodiment of the present disclosure; and

FIG. 6 illustrates a serving base station and a selected serving base station according to an exemplary embodiment of the present disclosure.

Throughout the drawings, like reference numerals will be understood to refer to like parts, components and structures.

### DETAILED DESCRIPTION OF THE INVENTION

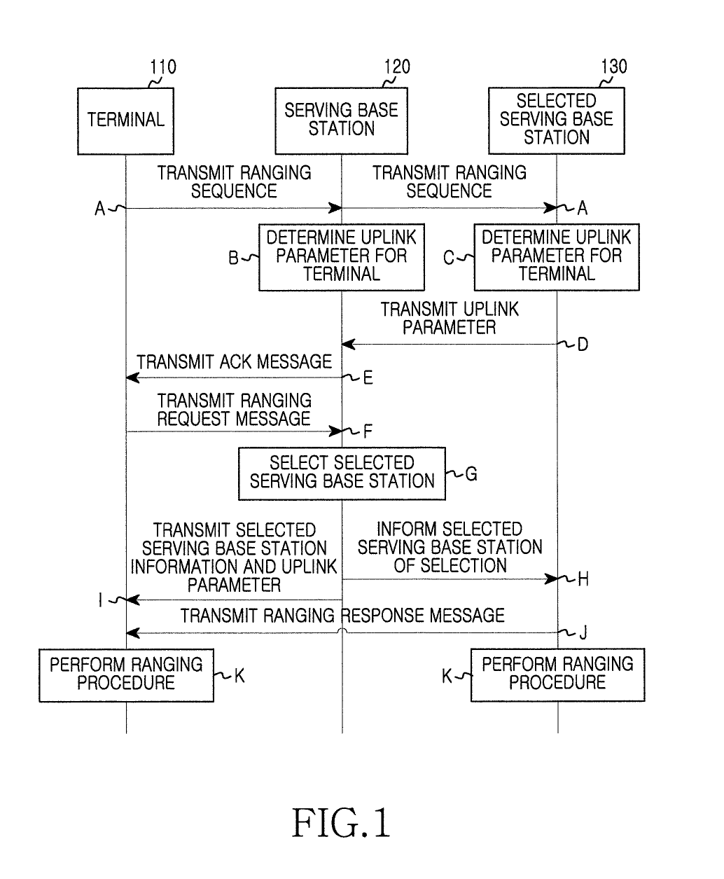

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present disclosure has an advantage of having a high efficiency in an aspect of performance because a terminal performs network entry to a base station where the terminal can show a maximum performance in a HetNet.

The following description with reference to the accompanying drawings is provided to assist in a comprehensive understanding of exemplary embodiments of the disclosure as defined by the claims and their equivalents. The present disclosure includes various specific details to assist in that understanding but these are to be regarded as merely exemplary. Accordingly, those of ordinary skill in the art will recognize that various changes and modifications of the embodiments described herein can be made without departing from the scope and spirit of the disclosure. Also, descriptions of well-known functions and constructions are omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of exemplary embodiments of the present disclosure are provided for illustration purpose only and not for the purpose of limiting the disclosure as defined by the appended claims and their equivalents.

Exemplary embodiments of the present disclosure provide a method and an apparatus for network entry in a HetNet.

The present disclosure relates to a method and an apparatus for network entry in a HetNet.

When information regarding a base station does not exist after a terminal performs booting, the terminal performs a network entry procedure that follows below.

First, the terminal scans a downlink channel and performs synchronization on a downlink physical layer with a base station. After that, the terminal obtains downlink and uplink parameters and performs synchronization on a downlink Medium Access Control (MAC) layer. After that, the terminal performs a ranging process and a negotiation regarding a basic capability with the base station, and performs an authentication and a key exchange process. After that, the terminal performs registration.

The terminal discriminates the type of a base station based on a detected cell ID and Cell_ID partitioning information. The terminal may select a base station depending on a cell type, a cell ID, a reception signal level, a degree of proximity to a cell, a service continuity/provided service, a capability of an out cell such as multiple input multiple output (MIMO) configuration, Multiple Carrier (MC) configuration, etc. In addition, a cell ID, a related carrier index, least significant bit (LSB) or most significant bit (MSB) of a base station identifier (BSID), etc. may be used to exclude a femto base station to which the terminal has not subscribed.

Here, the BSID (48 bits) or an induced closed subscription group identifier (CSGID) is an accurate identifier representing whether the terminal is allowed to access a target base station. The terminal may store a common identifier in a white list. The white list is a local table including an identifier of a femto base station to which the terminal has subscribed and which the terminal has been allowed to access. When a current femto cell is excluded, the terminal should continue to perform scanning until an appropriate base station is found.

When a femto base station is disposed in an inter-frequency assignment (FA), the terminal may perform the same procedure as an example of the same FA except that the terminal scans a different frequency band and performs an RF measurement for measuring a different frequency band.

When a femto base station and a macro base station are disposed in an intra-FA, the terminal may utilize the same procedure with respect to the macro base station and the femto base station.

In addition, in the example where the macro base station operates in the same frequency band and the femto base station operates in a different frequency band, combined performance of an inter-FA and an intra-FA may be possible.

FIG. 1 illustrates a network entry procedure of a terminal according to an exemplary embodiment of the present disclosure.

Referring to FIG. 1, the terminal 110 determines one base station to determine as a serving base station via downlink channel measurement. After that, the terminal transmits a ranging sequence for initial network entry to a serving base station 120 and other base stations (step a). The ranging sequence may be received by other base stations when the ranging sequence is receivable. In addition, a different ranging sequence is used for each base station, and a base station may be discriminated by a ranging sequence in use, and a base station may also discriminate a base station that uses a specific ranging sequence. The different base stations may include the selected serving base station 130. In the present disclosure, the ranging sequence may be called a base station access signal.

The serving base station 120 determines a reception signal-to-interference and noise ratio SINR, a time-frequency resource use state, and uplink parameter control information based on a ranging sequence transmitted by the terminal 110 (step b). The uplink parameter control information or an uplink parameter denotes a time, a frequency, power, etc. to be used by the terminal.

In the example where an extra resource for network entry of the terminal 110 exists and the reception power of the ranging sequence is equal to or greater than a threshold, a different base station also determines (step c) a reception SINR, a time-frequency resource use state, and an uplink parameter based on a ranging sequence to transmit and transfers (step d) the same to the serving base station 120.

After that, the serving base station 120 transmits an ACK message to the terminal 110 (step e). The ACK message includes the power, and time and frequency control indication of the serving base station 120. Alternatively, the ACK message may include an uplink parameter of a different base station received by the serving base station 120.

The terminal 110 controls an uplink parameter based on the indication of the serving base station 120. In addition, the terminal 110 generates a ranging request message and transmits the same to the serving base station 120 (step f). The present disclosure may denote the ranging request message by an access request message.

The ranging request message includes a list of base station IDs (BSIDs) of base stations that can be downlink synchronized. The list may be an ascending order or a descending order based on a downlink reference signal of each base station.

The serving base station 120 selects an accessible base station, that is, a base station to operate as the selected serving base station 130 based on a BSID included in the ranging request message (step g), and informs the relevant base station 130 that the base station 130 has been selected as the selected serving base station (step h). In addition, the serving base station 120 transmits a downlink message including information of the selected serving base station 130 and an uplink parameter regarding the selected serving base station 130 to the terminal 110 (step i). Here, the downlink message is different from a typical ranging response message. In addition, the downlink message includes power, a time, a frequency control indication, etc. to be used by the terminal 110. The present disclosure may denote the ranging response message by an access response message.

The terminal 110 controls an uplink parameter with respect to the selected serving base station 130 based on information transmitted by the serving base station 120. After that, the selected serving base station 130 transmits a ranging response message to the terminal 110 (step j). The ranging response message may be a general ranging response message and includes information for network entry of the terminal 110.

After that, the terminal 110 and the selected serving base station 130 perform a ranging procedure for network entry (step k).

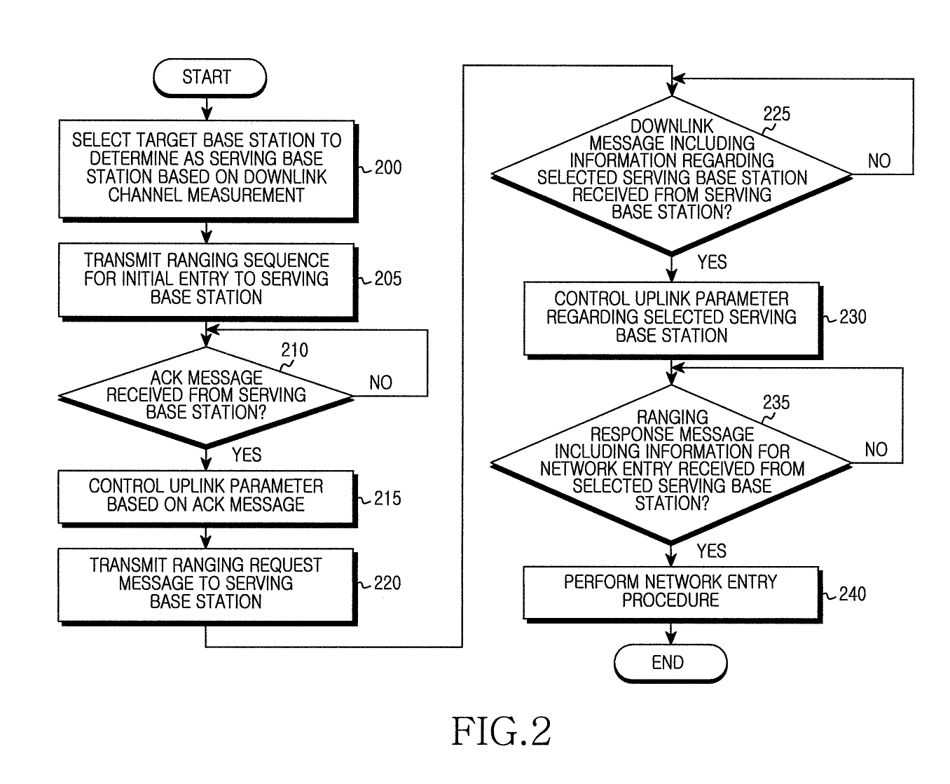

FIG. 2 illustrates a network entry procedure of a terminal according to an exemplary embodiment of the present disclosure.

Referring to FIG. 2, the terminal determines one target base station to determine as a serving base station via downlink channel measurement (step 200). After that, the terminal transmits a ranging sequence for initial network entry to the serving base station (step 205).

The ranging sequence may be received by other base stations when the ranging sequence is receivable. In addition, a different ranging sequence is used for each base station, and a base station may be discriminated by a ranging sequence in use, and a base station may also discriminate a base station that uses a specific ranging sequence.

When receiving an ACK message from the serving base station with respect to the ranging sequence (step 210), the terminal controls an uplink parameter based on indication of the serving base station included in the ACK message (step 215). In addition, the terminal generates a ranging request message and transmits the same to the serving base station (step 220).

The ACK message includes the power for the terminal, and time and frequency control indication of the serving base station. Alternatively, the ACK message may include an uplink parameter for the terminal of a different base station received by the serving base station. In addition, the ranging request message includes a list of base station IDs (BSIDs) of base stations that can be downlink synchronized. The list may be an ascending order or a descending order based on a downlink reference signal of each base station.

After that, when receiving a downlink message including information regarding a selected serving base station from the serving base station (step 225), the terminal controls an uplink parameter with respect to the selected serving base station based on information transmitted by the serving base station (step 230). Here, the downlink message is different from a typical ranging response message. In addition, the downlink message includes power, a time, a frequency control indication, etc.

When receiving a ranging response message including information regarding network entry of the terminal from the selected serving base station (step 235), the terminal performs a procedure for network entry with the selected serving base station (step 240).

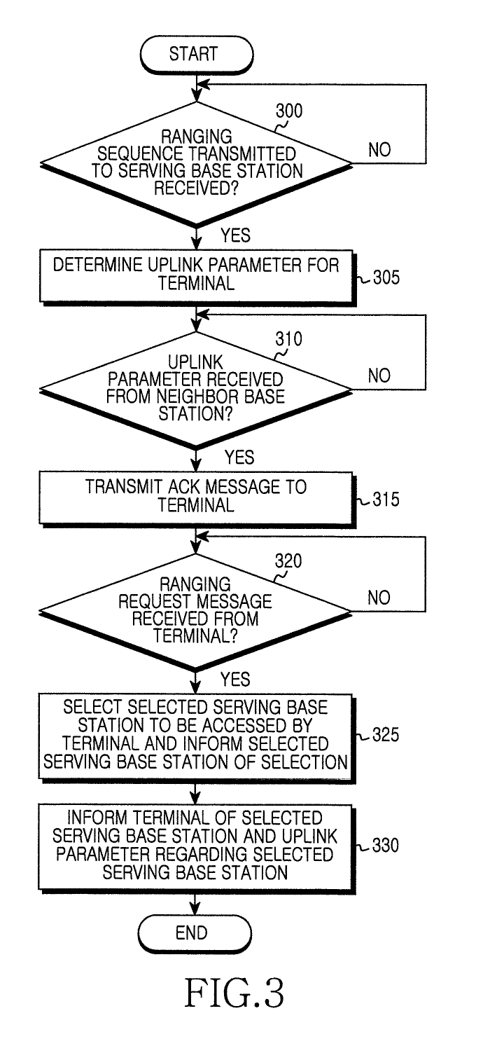

FIG. 3 illustrates a network entry procedure of a serving base station for a terminal according to an exemplary embodiment of the present disclosure.

Referring to FIG. 3, when receiving a ranging sequence for initial network entry of a terminal (step 300), the serving base station determines an uplink parameter for the terminal (step 305). The ranging sequence may be received by other base stations when the ranging sequence is receivable. In addition, a different ranging sequence is used for each base station, and a base station may be discriminated by a ranging sequence in use, and a base station may also discriminate a base station that uses a specific ranging sequence. The serving base station generates an ACK message and transmits the same to the terminal (step 315). When receiving an uplink parameter for the terminal from a different (neighbor) base station (step 310), the serving base station may incorporate information received from the neighbor base station or the different base station into the ACK message and transmit the same to the terminal (step 315).

That is, the ACK message includes the power for the terminal, and time and frequency control indication of the serving base station. Alternatively, the ACK message may include an uplink parameter for the terminal of a different base station received by the serving base station. In addition, the ranging request message includes a list of base station IDs (BSIDs) of base stations that can be downlink synchronized. The list may be an ascending order or a descending order based on a downlink reference signal of each base station.

After that, when receiving a ranging request message generated by the terminal (step 320), the serving base station selects a selected serving base station to be accessed by the terminal based on a BSID included in the ranging request message, and transmits a message informing this to the selected serving base station (step 325).

The ranging request message includes a list of base station IDs (BSIDs) of base stations that can be downlink synchronized. The list may be an ascending order or a descending order based on a downlink reference signal of each base station.

The serving base station transmits information regarding the selected serving base station and an uplink parameter regarding the selected serving base station to the terminal (step 330).

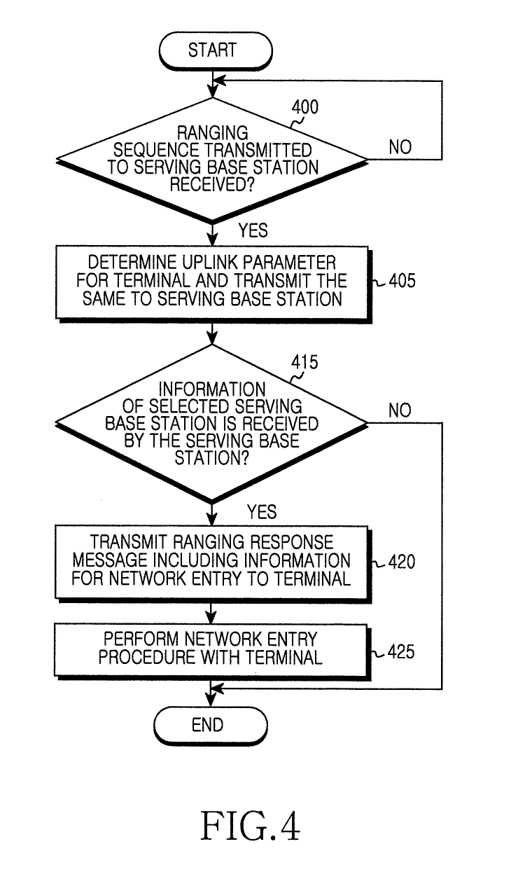

FIG. 4 illustrates a network entry procedure of a selected serving base station for a terminal according to an exemplary embodiment of the present disclosure.

Referring to FIG. 4, when a terminal receives a ranging sequence for initial network entry (step 400), the selected serving base station determines whether an extra resource for the network entry of the terminal exists and the reception power of the ranging sequence is equal to or greater than a threshold.

When the determination condition is met, the selected serving base station determines an uplink parameter for the terminal and transmits the determined uplink parameter to a serving base station (step 405). The ranging sequence may be received by other base stations when the ranging sequence is receivable. In addition, a different ranging sequence is used for each base station, and a base station may be discriminated by a ranging sequence in use, and a base station may also discriminate a base station that uses a specific ranging sequence.

When receiving a message including information of being a selected serving base station from the serving base station (step 415), the selected serving base station transmits a ranging response message including information regarding network entry to the terminal (step 420).

The selected serving base station performs a network entry procedure with the terminal (step 425).

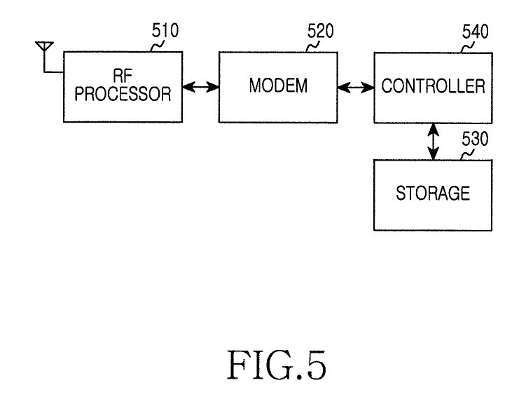

FIG. 5 illustrates a terminal according to an exemplary embodiment of the present disclosure.

Referring to FIG. 5, the terminal includes a Radio Frequency (RF) processor 510, a modem 520, a storage 530, and a controller 540.

The RF processor 510 performs a function for transmitting/receiving a signal via an RF channel such as band conversion and amplification of a signal. That is, the RF processor 510 up-converts a baseband signal provided from the modern 520 into an RF signal, and then transmits the same via an antenna, and down-converts an RF signal received via the antenna into a baseband signal.

The modem 520 performs a conversion function between a baseband signal and a bit line according to a physical layer standard of the system. That is, the modem 520 encodes and modulates a transmission bit line during data transmission. In addition, the modern 520 demodulates and decodes a reception bit line during data reception.

When an Orthogonal Frequency Division Multiplexing (OFDM) is used, during data transmission, the modem 520 generates complex symbols by encoding and modulating a transmission bit line, maps the complex symbols to subcarriers, and then configures OFDM symbols via Inverse Fast Fourier Transform (IFFT) and Cyclic Prefix (CP) insertion. In addition, during data reception, the modem 520 divides a baseband signal provided from the RF processor 510 on an OFDM basis, recovers signals mapped to subcarriers via FH , and then recovers a reception bit line via demodulation and decoding.

The storage unit 530 stores a basic program for operation of the terminal, an application program, and data such as user contents, etc. In addition, the storage 530 provides stored data in response to a request of the controller 540.

The controller 540 controls an overall operation of the terminal. For example, the controller 540 configures downlink data to provide the same to the modem 520, and analyzes uplink data provided from the modem 520.

The controller 540 determines one target base station to determine as a serving base station via downlink channel measurement. After that, the controller 540 transmits a ranging sequence for initial network entry to a serving base station. The ranging sequence may be received by other base stations when the ranging sequence is receivable. In addition, a different ranging sequence is used for each base station, and a base station may be discriminated by a ranging sequence in use, and a base station may also discriminate a base station that uses a specific ranging sequence.

When receiving an ACK message from the serving base station with respect to the ranging sequence, the controller 540 controls an uplink parameter based on indication of the serving base station. In addition, the controller 540 generates a ranging request message and transmits the same to the serving base station.

The ACK message includes the power, and time and frequency control indication of the serving base station. Alternatively, the ACK message may include an uplink parameter of a different base station received by the serving base station. In addition, the ranging request message includes a list of base station IDs (BSIDs) of base stations that can be downlink synchronized. The list may be an ascending order or a descending order based on a downlink reference signal of each base station.

When receiving a downlink message including information regarding a selected serving base station from the serving base station, the controller 540 controls an uplink parameter with respect to the selected serving base station based on the information transmitted by the serving base station.

Here, the downlink message is different from a typical ranging response message. In addition, the downlink message includes power, time, a frequency control indication, etc.

After that, when receiving a ranging response message including information for network entry of the terminal from the selected serving base station, the controller 540 performs rest of procedures for network entry with the selected serving base station.

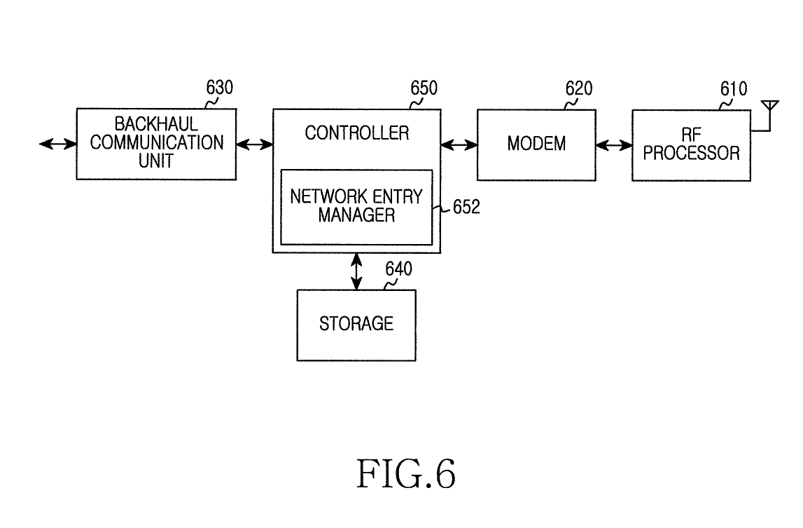

FIG. 6 illustrates a serving base station and a selected serving base station according to an exemplary embodiment of the present disclosure.

As illustrated in FIG. 6, the serving base station and the selected serving base station include an RF processor 610, a modem 620, a backhaul communication unit 630, a storage 640, and a controller 650.

The RF processor 610 performs a function for transmitting/receiving a signal via an RF channel such as band conversion and amplification of a signal. That is, the RF processor 610 up-converts a baseband signal provided from the modem 620 into an RF signal, and then transmits the same via an antenna, and down-converts an RF signal received via the antenna into a baseband signal.

The modem 620 performs a conversion function between a baseband signal and a bit line according to a physical layer standard of the system. That is, the modem 620 encodes and modulates a transmission bit line during data transmission. In addition, the modem 620 demodulates and decodes a reception bit line during data reception.

When an OFDM is used, during data transmission, the modem 620 generates complex symbols by encoding and modulating a transmission bit line, maps the complex symbols to subcarriers, and then configures OFDM symbols via Inverse Fast Fourier Transform (IFFT) and Cyclic Prefix (CP) insertion. In addition, during data reception, the modem 620 divides a baseband signal provided from the RF processor 610 on an OFDM basis, recovers signals mapped to subcarriers via FFT, and then recovers a reception bit line via demodulation and decoding.

The backhaul communication unit 630 provides an interface for performing communication with an upper system. That is, the backhaul communication unit 630 converts a bit line transmitted from the base station to an upper system into a physical signal, and converts a physical signal received from the controller into a bit line. The storage 640 store a basic program for operation of the base station, an application program, and data such as user contents, etc. In addition, the storage 640 provides stored data in response to a request of the controller 650.

The controller 650 controls overall operations of the serving base station and the selected serving base station. For example, the controller 650 configures downlink data to provide the same to the modem 620, and analyzes uplink data provided from the modem 620. In addition, the controller 650 includes a network entry manager 652.

Now, a serving base station is described. When receiving a ranging sequence for initial network entry of the terminal, the network entry manager 652 determines an uplink parameter for the terminal.

The ranging sequence may be received by other base stations when the ranging sequence is receivable. In addition, a different ranging sequence is used for each base station, and a base station may be discriminated by a ranging sequence in use, and a base station may also discriminate a base station that uses a specific ranging sequence. The serving base station generates an ACK message to transmit the same to the terminal.

When receiving an uplink parameter for the terminal from a neighbor base station, the network entry manager 652 may incorporate information received from the neighbor base station or a different base station into the ACK message, and transmit the same to the terminal.

That is, the ACK message may include the power, and time and frequency control indication for the terminal of the serving base station. Alternatively, the ACK message may include an uplink parameter of a different base station received by the serving base station. In addition, the ranging request message includes a list of base station IDs (BSIDs) of base stations that can be downlink synchronized. The list may be an ascending order or a descending order based on a downlink reference signal of each base station.

After that, when receiving the ranging request message generated by the terminal, the network entry manager 652 selects a selected serving base station which the terminal is to access, and transmits a message informing this to the selected serving base station. The ranging request message includes a list of BSIDs of base stations that can be downlink synchronized. The list may be an ascending order or a descending order based on a downlink reference signal of each base station.

After that, the network entry manager 652 transmits information regarding the selected serving base station and an uplink parameter for the serving base station to the terminal.

Now, the selected serving base station is described. When the terminal receives a ranging sequence for initial network entry, the network entry manager 652 determines whether an extra resource for network entry of the terminal exists and whether the reception power of the ranging sequence is equal to or greater than a threshold.

When the determination condition is met, the network entry manager 652 determines an uplink parameter for the terminal, and transmits the determined uplink parameter to the serving base station. The ranging sequence may be received by other base stations when the ranging sequence is receivable. In addition, a different ranging sequence is used for each base station, and a base station may be discriminated by a ranging sequence in use, and a base station may also discriminate a base station that uses a specific ranging sequence.

After that, when receiving a message including information informing a selected serving base station from the serving base station, the network entry manager 652 transmits a ranging response message including information regarding network entry to the terminal.

After that, the network entry manager 652 performs a network entry procedure with the terminal.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for network entry of a terminal in a heterogeneous network (HetNet), the method comprising:
transmitting a base station access signal for network entry to a serving base station;
receiving a response message from the serving base station;
controlling an uplink parameter based on an indication of the serving base station included in the response message;
generating an access request message and transmitting the access request message to the serving base station;
receiving a downlink response message comprising information regarding a selected serving base station from the serving base station;
receiving an access response message comprising information for network entry from the selected serving base station; and
performing a network entry procedure with the selected serving base station.

2. The method of claim 1 further comprising:
performing downlink channel measurement.

3. The method of claim 1, wherein the base station access signal is receivable by other base stations except the serving base station and is unique for each base station.

4. The method of claim 1, wherein the response message comprises one of a power, time, and frequency control indication for the terminal of the serving base station, and an uplink parameter for the terminal of a different base station received by the serving base station.

5. The method of claim 1, wherein the access request message comprises a list of base station identifications (BSIDs) of base stations that are downlink-synchronizable.

6. A method for operating a base station for network entry of a terminal in a heterogeneous network (HetNet), the method comprising:
receiving a base station access signal from a terminal;
when receiving an uplink parameter regarding the terminal from a different base station, transmitting the uplink parameter to the terminal that generates a response message comprising an uplink parameter;
receiving an access request message from the terminal;
determining a selected serving base station that the terminal is to access based on a base station identifier (ID) included in the access request message; and
transmitting information regarding the selected serving base station to the terminal.

7. The method of claim 6 further comprising:
transmitting a message comprising information informing a selected serving base station to the selected serving base station.

8. The method of claim 6, wherein the base station access signal is receivable by other base stations and is unique for each base station.

9. The method of claim 6, wherein the response message comprises a power, time, and frequency control indication for the terminal.

10. The method of claim 6, wherein the access request message comprises a list of base station identifications (BSIDs) of base stations that are downlink-synchronizable.

11. A method for operating a base station for network entry of a terminal in a heterogeneous network (HetNet), the method comprising:
receiving a base station access signal from a terminal;
determining whether reception power of the base station access signal is equal to or greater than a threshold;
when the reception power of the base station access signal is equal to or greater than the threshold, transmitting an uplink parameter regarding the terminal to a serving base station;
when receiving a message comprising information informing a selected serving base station from the serving base station, transmitting an access response message comprising information for network entry of the terminal to the terminal; and
performing a network entry procedure with the terminal.

12. The method of claim 11, wherein the base station access signal is receivable by other base stations and is unique for each base station.

13. An apparatus of a terminal for network entry in a heterogeneous network (HetNet), the apparatus comprising:
a modem configured to communicate with a base station; and
a controller configured to transmit a base station access signal for network entry to a serving base station, receive a response message from the serving base station, controlling an uplink parameter, generate an access request message, transmit the access request message to the serving base station based on indication of the serving base station included in the response message, receive a downlink response message comprising information regarding a selected serving base station from the serving base station, receive an access response message comprising information for network entry from the selected serving base station, and perform a network entry procedure with the selected serving base station.

14. The apparatus of claim 13, wherein the controller is further configured to perform downlink channel measurement.

15. The apparatus of claim 13, wherein the base station access signal is receivable by other base stations except the serving base station and is unique for each base station.

16. The apparatus of claim 13, wherein the response message comprises one of a power, time, and frequency control indication for the terminal of the serving base station, and an uplink parameter for the terminal of a different base station received by the serving base station.

17. The apparatus of claim 13, wherein the access request message comprises a list of base station identifications (BSIDs) of base stations that are downlink-synchronizable.

18. An apparatus of a base station for network entry of a terminal in a heterogeneous network (HetNet), the apparatus comprising:
a modem configured to communicate with the terminal;
a backhaul communication unit configured to communicate with a different base station; and
a network entry manager configured to receive a base station access signal from the terminal; when receiving an uplink parameter for the terminal from a different base station, transmit the uplink parameter to the terminal that generates a response message comprising the uplink parameter; receive an access request message from the terminal;
determine a selected base station which the terminal is to access based on a base station identifier (ID) included in the access request message; and transmit information regarding the selected serving base station to the terminal.

19. The apparatus of claim 18, wherein the network entry manager is further configured to transmit a message comprising information informing a selected serving base station to the selected serving base station.

20. The apparatus of claim 18, wherein the base station access signal is receivable by other base stations and is unique for each base station.

21. The apparatus of claim 18, wherein the response message comprises a power, time, and frequency control indication for the terminal.

22. The apparatus of claim 18, wherein the access request message comprises a list of base station identifications (BSIDs) of base stations that are downlink-synchronizable.

23. An apparatus of a base station for network entry of a terminal in a heterogeneous network (HetNet), the apparatus comprising:
a modem configured to communicate with the terminal;
a backhaul communication unit configured to communicate with a different base station; and
a network entry manager configured to receive a base station access signal from the terminal; determining whether reception power of the base station access signal is equal to or greater than a threshold; when the reception power of the base station access signal is equal to or greater than the threshold, transmit an uplink parameter for the terminal to a serving base station; when receiving a message comprising information informing a selected serving base station from the serving base station, transmit an access response message comprising information for network entry of the terminal to the terminal; and perform a network entry procedure with the terminal.

24. The apparatus of claim 23, wherein the base station access signal is receivable by other base stations and is unique for each base station.
